(19) United States
(12) Patent Application Publication
(10) Pub. No.: US 2026/0221606 A1
(43) Pub. Date: Jul. 30, 2026

(54) POWER STORAGE DEVICE

(71) Applicant: Panasonic Energy Co., Ltd., Moriguchi-shi, Osaka (JP)

(72) Inventor: Tomomichi UEDA, Osaka (JP)

(21) Appl. No.: 19/147,503

(22) PCT Filed: Jan. 5, 2024
(86) PCT No.: PCT/JP2024/000056

§ 371 Date: Jul. 11, 2025

(30) Foreign Application Priority Data
Jan. 12, 2023 (JP) 2023-003162

(51) Int. Cl. H01M 50/533; H01M 50/528; H01M 50/538

(52) U.S. Cl. CPC H01M 50/533; H01M 50/528; H01M 50/538

(57) ABSTRACT

A power storage device includes: an electrode group including a first electrode and a second electrode; a plurality of tabs each connected to the first electrode and overlapping each other; and a terminal member positioned opposite the electrode group with the plurality of tabs therebetween, the terminal member being welded to the plurality of tabs through irradiation with a laser in the direction from the terminal member toward the electrode group. At least a tab of the plurality of tabs that is located closest to the electrode group has a folded portion that is a part of the tab folded over itself and that has a part of a laser processing trace by the laser.

### TECHNICAL FIELD

The present disclosure relates to a power storage device.

### BACKGROUND ART

Conventionally, power storage devices that store electric power for supply to a load device are known (e.g., Patent Literature 1). The power storage device of Patent Literature 1 includes a stacked electrode body including a positive electrode and a negative electrode, a positive electrode tab group in which positive electrode tabs protruding from the positive electrode are stacked, and a negative electrode tab group in which negative electrode tabs protruding from the negative electrode are stacked, wherein the positive electrode tab group and the negative electrode tab group each have an extension part extending in a predetermined direction and a folded portion folded back toward the extension part. The power storage device further has a retention portion that retains the folded portion in a state of being folded back toward the extension part. A welded part formed by welding an area where the folded portion and the extension part overlap is exemplified as the retention portion.

### CITATION LIST

### Patent Literature

Patent Literature 1: Japanese Laid-Open Patent Publication No. 2021-44148

### SUMMARY OF INVENTION

### Technical Problem

However, depending on the power storage device configuration, the plurality of tabs connected to an electrode of an electrode group may be welded through irradiation with a laser in the direction toward the electrode group. In this case, when the laser output is excessively high, the electrode body may be damaged. When the laser output is insufficient by contrast, some of the tabs (particularly a tab located closest to the electrode group) may not be properly welded, leading to a welding failure. In consideration of this situation, one of the objects of the present disclosure is to easily achieve both avoidance of damage to the electrode body and avoidance of welding failures in the plurality of tabs.

### Solution to Problem

One aspect of the present disclosure relates to a power storage device. The power storage device includes an electrode group including a first electrode and a second electrode; a plurality of tabs each connected to the first electrode and overlapping each other; and a terminal member positioned opposite the electrode group with the plurality of tabs therebetween, the terminal member being welded to the plurality of tabs through irradiation with a laser in a direction from the terminal member toward the electrode group, wherein at least a tab located closest to the electrode group among the plurality of tabs has a folded portion that is a part of the tab folded over itself and that includes a part of a laser processing trace by the laser.

### Advantageous Effects of Invention

According to the present disclosure, it is possible to easily achieve both avoidance of damage to the electrode body and avoidance of welding failures in the plurality of tabs.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF DRAWINGS

FIG. 1 is a schematic longitudinal cross-sectional view of a power storage device according to an embodiment.

FIG. 2 is a schematic longitudinal cross-sectional view of a power storage device according to a variation.

### DESCRIPTION OF EMBODIMENTS

Embodiments of a power storage device according to the present disclosure will be described below. However, the present disclosure is not limited to the embodiments described below. In the following description, specific numerical values and materials may be exemplified in some cases, but other numerical values and other materials may be adopted as long as the effects of the present disclosure can be obtained.

The power storage device according to the present disclosure may be a primary battery such as a lithium primary battery or a secondary battery such as an alkaline storage battery (e.g., a nickel-hydrogen battery or a nickel-cadmium battery), a lithium-ion secondary battery, or a lithium-metal secondary battery. Alternatively, it may be a power storage device (e.g., a lithium-ion capacitor or an electric double-layer capacitor) in which at least one of a positive electrode and a negative electrode is a polarizable electrode that exhibits a capacity by a non-Faraday reaction. The power storage device according to the present disclosure includes an electrode group, a plurality of tabs, and a terminal member.

The electrode group includes a first electrode and a second electrode. The electrode group may be a wound electrode group in which the first electrode and the second electrode are wound around a separator, with the separator in between, for example. The outer shape of the electrode group may be, for example, columnar or prismatic. Either the first electrode or the second electrode is a positive electrode, while the other of the first electrode or the second electrode is a negative electrode.

The first electrode, the second electrode, and the separator may each have an elongated sheet shape (or a band shape). The first electrode may include an elongated sheet-shaped first current collector and a first active material layer carried on the first current collector. The second electrode may include an elongated sheet-shaped second current collector and may further include a second active material layer carried on the second current collector. The separator may be constituted of a porous sheet having ion permeability and insulating properties. Examples of the porous sheet include thin films having micropores, woven fabrics, and nonwoven fabrics.

Hereinafter, description will be made using a lithium-ion secondary battery as an example. The first active material layer may be provided on both sides of the first current collector or may be provided on one side of the first current collector. When the first electrode is a positive electrode, the first current collector is a positive electrode current collector (possibly constituted of an aluminum foil or an aluminum alloy foil, for example), and the first active material layer is a positive electrode active material layer (possibly containing lithium-containing transition metal oxide, for example). When the first electrode is a negative electrode, the first current collector is a negative electrode current collector (possibly constituted of a copper foil or a copper alloy foil, for example), and a negative electrode active material layer (possibly containing a carbonaceous material, for example) may be provided as the first active material layer.

The plurality of tabs are each connected to the first electrode and overlapping each other. The plurality of tabs may be a separate entity from the first electrode or may be unified with the first electrode. The plurality of tabs may be constituted of conductors such as metal foils. The number of the tabs is not particularly limited, and may be, for example, two or more, three or more, or four or five or more. The number of the tabs may be 15 or less. The thickness of each tab is not particularly limited and may be 40 μm or more and 120 μm or less, for example.

The terminal member is positioned opposite the electrode group with the plurality of tabs therebetween. The terminal member is welded to the plurality of tabs through irradiation with a laser in the direction from the terminal member toward the electrode group. In the above configuration, the terminal member is electrically connected to the first electrode via the plurality of tabs. The terminal member may be constituted of a conductor.

Here, in laser welding of the terminal member and the plurality of tabs, it is necessary to obtain laser power sufficient to weld all the tabs. However, when the laser power is excessively high, the laser may penetrate the tab located closest to the electrode group to damage the electrode body. In other words, the laser power necessary to reach the tab closest to the electrode group among the plurality of tabs without penetrating the tab is required. However, it is difficult to consistently achieve the required laser power in an actual manufacturing process with various tolerances.

To address the above requirement, in the power storage device of the present disclosure, at least the tab of the plurality of tabs that is located closest to the electrode group has a folded portion that is a part of the tab folded over itself and that includes a part of a laser processing trace by the laser. In this case, since at least a part of the folded portion of the tab located closest to the electrode group need only be laser welded, it is easy to satisfy the requirement for the laser power. For example, when the folded portion is a part of the tab that is double folded over itself, the allowable range of the laser power that does not penetrate the tab located closest to the electrode group is substantially doubled compared to a case without the folded portion. Thus, it is possible to easily achieve both avoidance of damage to the electrode body and avoidance of welding failures in the plurality of tabs.

Of the plurality of tabs, only the tab located closest to the electrode group may have the folded portion. In this case, the effect of the present disclosure of increasing the allowable range of the laser power can be achieved with the minimum space required. That is, although the tab having the folded portion occupies more space in the power storage device than a tab without such a part, it is sufficient for only the tab located closest to the electrode group to have the folded portion to achieve the effects of the present disclosure. Therefore, it is preferable that only the tab located closest to the electrode group has the folded portion. However, a tab besides the tab located closest to the electrode group may have the folded portion, and the number and arrangement of the tabs having the folded portion are not particularly limited.

The folded portion may be a part of the tab that is double folded over itself. In this case, the effect of the present disclosure of increasing the allowable range of laser output can be achieved while reducing the disadvantages of space occupation by the folded portion. The number of folds required to form the folded portion of the tab is not particularly limited.

According to the present disclosure, provision of the folded portion, for example, on the tab located closest to the electrode body makes it possible to easily achieve both avoidance of damage to the electrode body and avoidance of welding failures in the plurality of tabs, as described above.

Hereinafter, an example of the power storage device according to the present disclosure will be specifically described with reference to the drawings. The elements of configuration described above are applicable to elements of configuration of the power storage device in the example described below. The elements of configuration of the power storage device in the example described below can be altered based on the above description. Further, the matters described below may be applied to the above-described embodiment. Among the elements of configuration of the example of the power storage device described below, an element of configuration that is not essential to the power storage device according to the present disclosure may be omitted. It should be noted that the drawings indicated below are schematic and do not accurately reflect the shape or number of actual members.

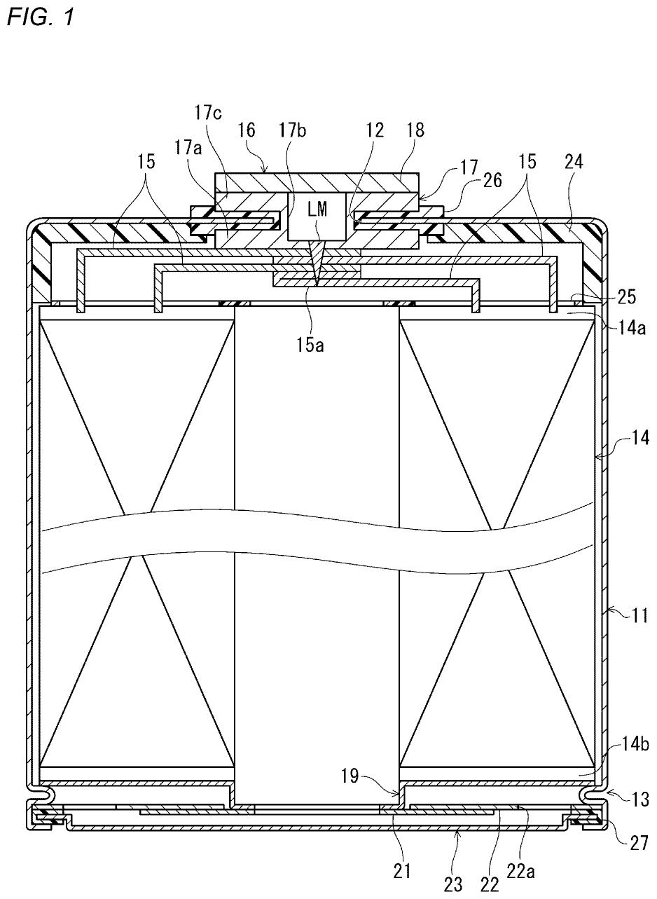

The following describes an embodiment of the present disclosure. A power storage device 10 of the present embodiment is a secondary battery capable of repetitive charging and discharging, and may be, for example, a lithium-ion secondary battery or a lithium secondary battery (lithium-metal secondary battery). As illustrated in FIG. 1, the power storage device 10 includes a case 11, an electrode group 14, a plurality of tabs 15, a positive electrode terminal 16, an end face current collector plate 19, a negative electrode current collector plate 22, and a sealing plate 23.

The case 11 is formed in a bottomed cylindrical shape having an opening at one end (lower end in FIG. 1). The case 11 is constituted of a metal. A through hole 12 through which the positive electrode terminal 16 is inserted is formed in the central part of the bottom of the case 11. The case 11 houses a non-illustrated liquid electrolyte together with the electrode group 14. In the vicinity of the opening in the case 11, a recess 13 is formed which is recessed radially inward from the case 11.

The electrode group 14 includes a positive electrode 14a and a negative electrode 14b. The electrode group 14 is a wound electrode group in which the positive electrode 14a and the negative electrode 14b are wound around a separator (not illustrated) with the separator in between. The electrode group 14 is substantially columnar in shape as a whole. The positive electrode 14a is an example of the first electrode, and the negative electrode 14b is an example of the second electrode.

Each of the plurality of tabs 15 is connected to the positive electrode 14a and overlapping each other. The plurality of tabs 15 may be overlapping each other in a direction in which the winding axis of the electrode group 14 extends (the vertical direction in FIG. 1). The plurality of tabs 15 are constituted of conductors. In the present embodiment, the number of the tabs 15 is 8, but is not limited thereto. Only four of the eight tabs 15 are illustrated in FIG. 1. The thickness of each tab 15 may be 60 μm or more and 80 μm or less.

Between the electrode group 14 and the bottom of the case 11, an insulating member 24 is provided for electrically insulating the two. The insulating member 24 is constituted of an insulative resin, for example. The insulating member 24 may be attached to the bottom of the case 11.

The positive electrode terminal 16 is positioned opposite the electrode group 14 with the plurality of tabs 15 therebetween. The positive electrode terminal 16 is inserted in the through hole 12 at the bottom of the case 11 and penetrates the bottom of the case 11. The positive electrode terminal 16 is constituted of a metal, and a rivet or the like is used. The positive electrode terminal 16 is insulated from the case 11 through a positive electrode gasket 26 constituted of an insulating material. An insulating plate 25 for electrically insulating the positive electrode terminal 16 and the electrode group 14 is placed between the two.

The positive electrode terminal 16 includes a first terminal member 17 extending in and out of the case 11, and a disk-shaped second terminal member 18 joined to the first terminal member 17 and exposed to the outside of the case 11. The first terminal member 17 includes a disk-shaped first portion 17a, a hollow cylindrical second portion 17b that extends continuously from the first portion 17a and that is inserted in the through hole 12, and a third portion 17c that extends radially outward from an end of the second portion 17b and to which the second terminal member 18 is joined. The first terminal member 17 is welded at the first portion 17a to the plurality of tabs 15 through irradiation with a laser in the direction from the first terminal member 17 toward the electrode group 14. Accordingly, the positive electrode terminal 16 is electrically connected to the positive electrode 14a via the plurality of tabs 15 to function as an external positive electrode terminal of the power storage device 10. The first terminal member 17 is an example of the terminal member.

Among the plurality of tabs 15, at least the tab 15 that is located closest to the electrode group 14 (the lowermost tab 15 in FIG. 1) has a folded portion 15a that is a part (specifically, a part on the tip end side) of the tab 15 folded over itself and that includes a part of a laser processing trace LM made by the laser. The folded portion 15a is located opposite the electrode group 14 with the insulating plate 25 therebetween. The laser processing trace LM may be formed on only one of two tab portions constituting the folded portion 15a which is located closer to the first terminal member 17 or may be formed on the two tab portions.

Preferably, only the tab 15 of the plurality of tabs 15 located closest to the electrode group 14 has the folded portion 15a. Preferably, the folded portion 15a is a part of the tab 15 that is double folded over itself.

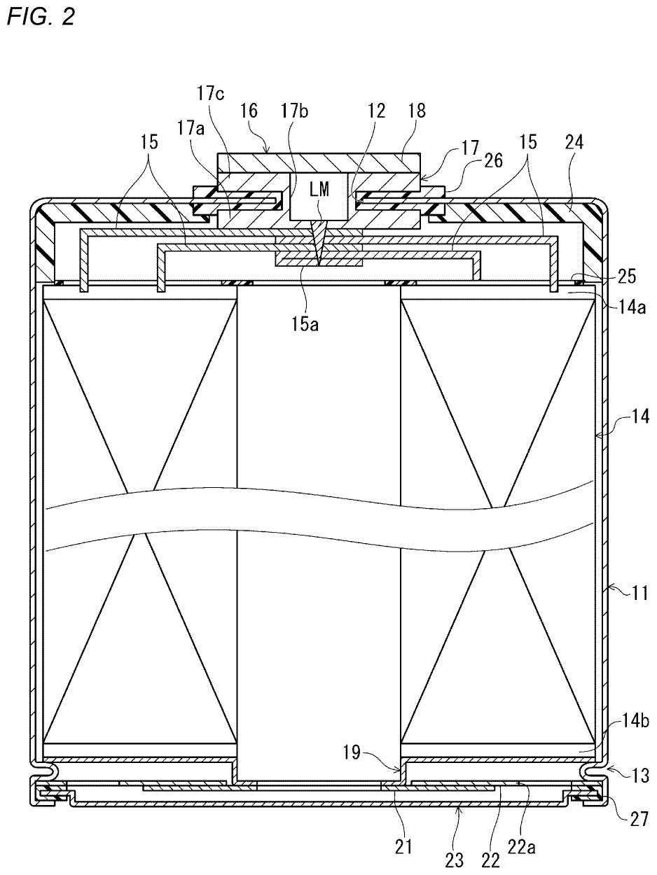

The folded portion 15a in the present embodiment is formed by folding back a part of the tab 15 located closest to the electrode group 14 in a direction away from the electrode group 14 (upward in FIG. 1). As in FIG. 2 illustrated as a variation, the folded portion 15a may be formed by folding back a part of the tab 15 located closest to the electrode group 14 in a direction toward the electrode group 14 (downward in FIG. 2).

The end face current collector plate 19 is constituted of a metal. The shape of the end face current collector plate 19 is not particularly limited and may be substantially cross-shaped as a whole, for example. The end face current collector plate 19 is connected to the negative electrode 14b of the electrode group 14, for example, by laser welding.

The negative electrode current collector plate 22 is electrically connected to the end face current collector plate 19 via a metal-made connection plate 21 (which may be formed in a ring-like shape, for example). In the above configuration, the negative electrode current collector plate 22 is electrically connected to the negative electrode 14b. The negative electrode current collector plate 22 and the connection plate 21 may be welded (e.g., laser welded) to each other. The connection plate 21 and the end face current collector plate 19 may be welded (e.g., laser welded) to each other. The negative electrode current collector plate 22 may be directly connected to the end face current collector plate 19. In this case, the connection plate 21 is unnecessary. The negative electrode current collector plate 22 has one or more injection holes 22a through which the liquid electrolyte is to be injected into the case 11. The negative electrode current collector plate 22 is welded (e.g., laser welded) at the outer edge thereof to the recess 13 of the case 11. In the above configuration, the case 11 is electrically connected to the negative electrode 14b via the negative electrode current collector plate 22 and the like.

The sealing plate 23 seals the opening of the case 11. The sealing plate 23 is constituted of a metal and is substantially disc-shaped. The sealing plate 23 is insulated from the case 11 through a negative electrode gasket 27. The sealing plate 23 in the present embodiment is electrically connected to neither the positive electrode 14a nor the negative electrode 14b of the electrode group 14 but is not limited thereto. The sealing plate 23 includes an explosion-proof mechanism (not illustrated) that is activated upon the internal pressure of the case 11 exceeding a predetermined value.

### -Method for Manufacturing Power Storage Device-

A method for manufacturing the power storage device 10 of the present embodiment includes: a first step of preparing an electrode group 14 including a first electrode 14a and a second electrode 14b, a plurality of tabs 15 being connected to the first electrode 14a; a second step of placing parts of the plurality of tabs 15 overlapping each other; a third step of forming a folded portion 15a by double-folding, over itself, a part of at least a tab 15 of the plurality of tabs 15 that is located closest to the electrode group 14; a fourth step of placing the first terminal member 17 on a side opposite the electrode group 14 with the plurality of tabs 15 therebetween; and a fifth step of welding the first terminal member 17 and the plurality of tabs 15 overlapping each other through irradiation with a laser in the direction from the first terminal member 17 toward the electrode group 14. In either or both the fourth step and the fifth step, it is possible, for example, that a rod-shaped jig is inserted into the hollow of the electrode group 14 and the plurality of tabs 15 are sandwiched between the jig and the first terminal member 17. In the fifth step, a part of a laser processing trace LM by the laser is formed on at least a part of the folded portion 15a of the tab 15 located closest to the electrode group 14. The execution order of the steps is not particularly limited, and a plurality of steps can be executed simultaneously.

### «Supplemental Remarks»

According to the above description of the embodiments, the following techniques are disclosed.

### (Technique 1)

A power storage device including:
an electrode group including a first electrode and a second electrode;
a plurality of tabs each connected to the first electrode and overlapping each other, and a terminal member positioned opposite the electrode group with the plurality of tabs therebetween, the terminal member being welded to the plurality of tabs through irradiation with a laser in a direction from the terminal member toward the electrode group,
wherein at least a tab located closest to the electrode group among the plurality of tabs has a folded portion that is a part of the tab folded over itself and that includes a part of a laser processing trace by the laser.

### (Technique 2)

The power storage device according to Technique 1, wherein only the tab located closest to the electrode group among the plurality of tabs has the folded portion.

### (Technique 3)

The power storage device according to Technique 1 or 2, wherein the folded portion is a part of the tab that is double folded over itself.

Although the present invention has been described in terms of the presently preferred embodiments, it is to be understood that such a disclosure is not to be interpreted as limiting. Various alterations and modifications will no doubt become apparent to those skilled in the art to which the present invention pertains, after having read the above disclosure. Accordingly, it is intended that the appended claims be interpreted to cover all alterations and modifications as fall within the true spirit and scope of the invention.

### INDUSTRIAL APPLICABILITY

The present disclosure can be utilized for power storage devices.

### REFERENCE SIGNS LIST

10: power storage device
   11: case
      12: through hole
      13: recess
   14: electrode group
      14a: positive electrode (first electrode)
      14b: negative electrode (second electrode)
   15: tab
      15a: folded portion
      16: positive electrode terminal
      17: first terminal member (terminal member)
         17a: first portion
         17b: second portion
         17c: third portion
      18: second terminal member
   19: end face current collector plate
   21: connection plate
   22: negative electrode current collector plate
      22a: injection hole
   23: sealing plate
   24: insulating member
   25: insulating plate
   26: positive electrode gasket
   27: negative electrode gasket
LM: laser processing trace

1. A power storage device comprising:
an electrode group including a first electrode and a second electrode;
a plurality of tabs each connected to the first electrode and overlapping each other; and
a terminal member positioned opposite the electrode group with the plurality of tabs therebetween, the terminal member being welded to the plurality of tabs through irradiation with a laser in a direction from the terminal member toward the electrode group,
wherein at least a tab located closest to the electrode group among the plurality of tabs has a folded portion that is a part of the tab folded over itself and that includes a part of a laser processing trace by the laser.

2. The power storage device according to claim 1,
wherein only the tab located closest to the electrode group among the plurality of tabs has the folded portion.

3. The power storage device according to claim 1,
wherein the folded portion is a part of the tab that is double folded over itself.

4. The power storage device according to claim 2,
wherein the folded portion is a part of the tab that is double folded over itself.
